(19) United States
(12) Patent Application Publication
(10) Pub. No.: US 2017/0041422 A1
(43) Pub. Date: Feb. 9, 2017

(54) METHOD AND SYSTEM FOR RETRIEVING A CONTENT MANIFEST IN A NETWORK

(71) Applicant: Futurewei Technologies, Inc., Plano, TX (US)

(72) Inventor: Cedric Westphal, San Francisco, CA (US)

(21) Appl. No.: 14/821,316

(22) Filed: Aug. 7, 2015

(51) Int. Cl. H04L 29/08; H04L 29/06; H04L 12/911; H04L 29/12

(52) U.S. Cl. CPC H04L 67/2847; H04L 61/1511; H04L 67/02; H04L 67/42; H04L 47/70

(57) ABSTRACT

Content is retrieved in a network by first requesting a manifest from a manifest server by a network controller in response to a query from a client node. The manifest is an extensible description of content to be requested. The network controller may modify the manifest to include network information pertinent to the content, such as its location, by adding an appendix including changes and additions to the manifest. The modified manifest is provided to the client node. Based on information in the modified manifest, the client node sends a request for the associated content. The network controller allocates resources and path selection for retrieval of the content. The network controller provides the retrieved content to the client node. If the network controller caches the retrieved content, the manifest is updated with the local cache information and provided to the manifest server to update its records.

### TECHNICAL FIELD

The present disclosure relates in general to content delivery techniques and more particularly to a method and system for retrieving a content manifest in a network.

### BACKGROUND

Dynamic streaming of multimedia content has been standardized in Motion Picture Experts Group (MPEG) Dynamic Adaptive Streaming over HTTP (DASH), or fully MPEG-DASH. Multimedia content is captured and stored on a Hypertext Transport Protocol (HTTP) server and is delivered using HTTP. The content exists on the server in two parts: 1) Media Presentation Description (MPD) is an Extensible Markup Language (XML) document which describes a manifest of the available content, its various alternatives, their URL addresses, and other characteristics; and 2) Segments which contain the actual multimedia bit streams in the form of alternative chunks, in single or multiple files. A DASH MPD statically specifies different locations for content. The MPD includes one or multiple periods, where a period is an interval of the program along the temporal axis. Each period has a starting time and duration and includes one or multiple adaptation sets. An adaptation set provides the information about one or multiple media components and its various encoded alternatives. For instance, an adaptation set may contain the different bitrates of the video component of the same multimedia content. Another adaptation set may contain the different bitrates of the audio component (e.g. lower quality stereo and higher quality surround sound) of the same multimedia content. Each adaptation set usually includes multiple representations. A representation is an encoded alternative of the same media component, varying from other representations by bitrate, resolution, number of channels, or other characteristics. Each representation includes one or multiple segments. Segments are the media stream chunks in temporal sequence. Each segment has a URI, i.e. an addressable location, on a server which can be downloaded using HTTP GET or HTTP GET with byte ranges.

In order to play the content, the DASH client first obtains the MPD. The MPD can be delivered using HTTP, email, thumb drive, broadcast or other transports. The DASH client may perform a Domain Name System (DNS) query to obtain an IP address for the location of the MPD. The DASH client requests and receives the MPD. The DASH client then parses the MPD XML document. By parsing the MPD, the DASH client learns about the timing of the program, the availability of media content, the media types, resolutions, minimum and maximum bandwidths and the existence of various encoded alternatives of multimedia components, the accessibility features and the required digital right management (DRM), the location of each media component on the network and other characteristic of the content. The DASH client then selects the set of representations it will use based on descriptive elements in the MPD, the capabilities of the client, and choices of its user. Each representation's description includes information about its segments, which enables requests for each segment to be formulated in terms of HTTP URL and byte range. For live presentations, the MPD also provides segment availability start time and availability end time, approximate media start time, and fixed or variable duration of segments. From the representations, the DASH client selects the appropriate encoded alternative segments and starts streaming of the content by fetching the segments using HTTP GET requests. Further DNS name resolution may be performed to identify the location of the selected segments. The DASH client builds a time-line and starts playing the multimedia content by requesting appropriate subsequent media segments. After appropriate buffering to allow for network throughput variations, the client continues fetching the subsequent segments and also monitors the bandwidth fluctuations of the network. Depending on its measurements, the client decides how to adapt to the available bandwidth by fetching segments of different alternatives (with lower or higher bitrate) to maintain an adequate buffer.

There are several limitations in the MPEG-DASH standard. MPEG-DASH is limited to streaming of video and related audio content. Moreover, the MPD is pre-configured and not subject to alteration by network entities in response to network conditions. The MPD is processed by the requester of content only and not analyzed by network entities as the MPD traverses through the network.

### SUMMARY

From the foregoing, it may be appreciated by those skilled in the art that a need has arisen to create a technique to signal properties of all content prior to retrieval. In accordance with the present disclosure, a method and system for retrieving a content manifest in a network are provided that greatly reduce and substantially eliminate the problems associated with conventional content retrieval techniques.

In accordance with an embodiment, a method for retrieving a content manifest in a network includes requesting a manifest from a manifest server in response to a query from a client node. The manifest is an extensible description of content to be requested. The manifest is received from the manifest server, inspected, and modified to include network information pertaining to the content. The modified manifest is provided to the client node for determining how to request the content.

The present disclosure describes many technical advantages over conventional identity systems. For example, one technical advantage is to retrieve a manifest providing a description of content prior to requesting the content. Another technical advantage is to modify the manifest with network information pertinent to the described content prior to forwarding to the requesting node. Yet another technical advantage is to use the request for a manifest as explicit control signaling to allocate resources and path selection for content delivery. Other technical advantages may be readily apparent to and discernable by those skilled in the art from the following figures, description, and claims.

### BRIEF DESCRIPTION OF THE DRAWINGS

For a more complete understanding of the various embodiments of the present invention and the advantages thereof, reference is now made to the following description taken in conjunction with the accompanying drawings, wherein like reference numerals represent like parts, in which:

FIG. 1 illustrates a network architecture for retrieving content in accordance with the present disclosure;

FIG. 2 depicts an example structure for a manifest describing content within the network architecture;

FIG. 3 illustrates a process flow for retrieving content in the network architecture according to the features of the present disclosure; and

FIG. 4 is a block diagram that illustrates an example structure of a network controller upon which an embodiment of the invention may be implemented.

### DETAILED DESCRIPTION

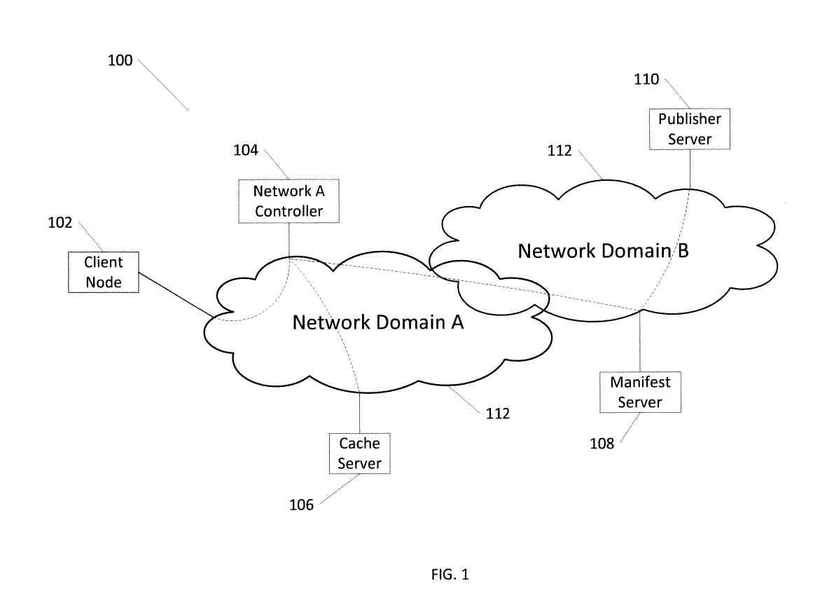

FIG. 1 shows an example of a network architecture 100 for signaling properties of all content objects prior to routing. Network architecture 100 includes the following network entities—at least one client node 102, at least one network controller 104, at least one cache server 106, at least one manifest server 108, and at least one publisher server 110. The elements of network architecture 100 are coupled to each other through one or more network domains 112. Client node 102 may be a personal computer, tablet, smartphone, other device capable of requesting and receiving content information. Network controller 104 may be a router, switch, server, or other network element that interfaces with client node 102 and controls network resources for the requesting and transferring of content information in network architecture 100. Cache server 106 may be any database, memory, or other storage device capable of maintaining content information within network architecture 100. Manifest server 108 may be any network element or device capable of maintaining manifest information associated with content objects stored in network architecture 100. Manifest server 108 may be a special type of Domain Name System (DNS) server and operate in a similar fashion thereto. Publisher server 110 may be any content provider entity generating content objects and associated manifests accessible in network architecture 100. Network Domain 112 may be a public or private data network or a combination of both. Though shown with two network domains 112, network architecture 100 may include any number of network domains 112 and each network entity may be in a separate network domain 112 or two or more network entities may belong to a same network domain 112.

In a general operation, network controller 104 (or some other ingress node) is able to make routing or prioritization decisions and can modify a manifest. A client node 102 requests a manifest for a specific file foo.mp4 and the manifest request is processed by network controller 104. Network controller forwards the manifest request to manifest server 108 and the manifest is subsequently returned to network controller 104. Network controller 104 inspects the manifest in one embodiment by using a specific port of the returned manifest as a way to filter these packets, though other mechanisms may be used to identify the manifest. Network controller 104 may recognize that file foo.mp4 is cached locally. Network controller 104, if allowed, modifies the manifest to include the cached location of foo.mp4 and forwards the manifest to client node 102. Network controller 104, managing content using the information brought by the manifest, makes a caching decision by keeping statistics of what content goes through the network. Client node 102 uses the information in the manifest to request the associated content.

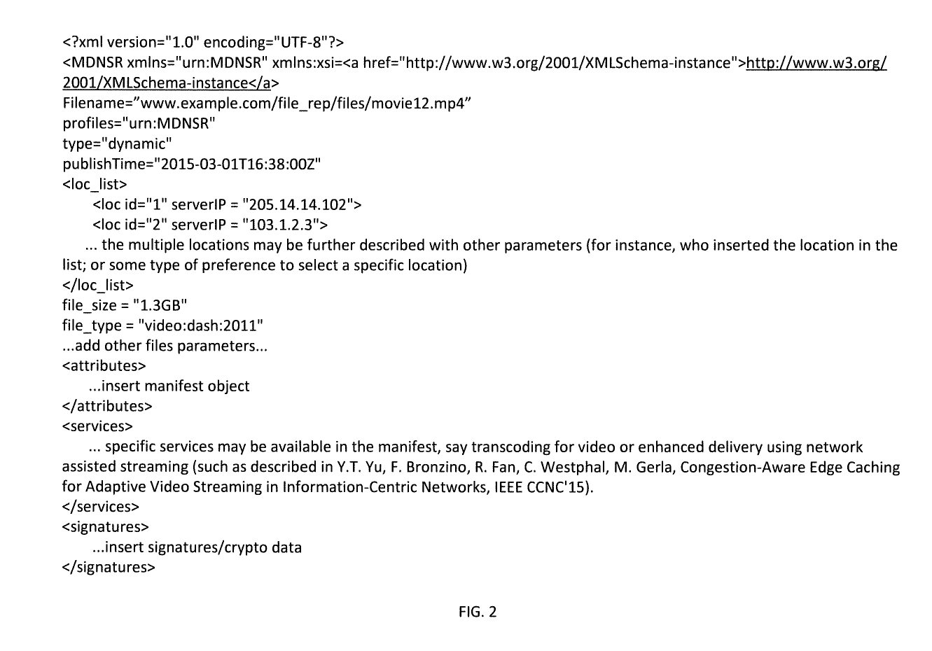

FIG. 2 shows an example of a format for a manifest. A manifest is an extensible description of content created by publisher server 110. The manifest may be in the form of an XML packet, YANG model, or another description language. A manifest may describe functions as well as content objects. A manifest includes the following elements—Name, Validation, Location, Type, Network, and Access. The Name element provides the name for the object being requested. The Validation element is basic authentication/cryptographic information to ensure that the other information in the manifest corresponds to the specified object/function. The Validation element may be in the form of a signature associated with the content publisher or an authorized representative using a private key. In this manner, any entity in network architecture 100 may check a validity of the manifest. The Location element lists potential IP addresses or other resolution servers which can resolve to IP addresses for the content object. The Type element allows for different types of manifests to be used in the network. For example, the Type element may include an indication that the manifest includes a DASH MPD as a subfield inside the manifest. As another example, the Type element may indicate that the manifest is carrying the content object if the content object is less than a threshold amount. The Network element includes control plane information for a network operator such as packet length (# of chunks, size of chunks) and quality of service (QoS) requirements (delay, jitter) if applicable and if supported by network architecture 100. The Access element includes information concerning credentials required by the client node 102 to access the content object. The manifest may be in an extensible format, such as in a Type-Length-Value (TLV) representation, in order to add other elements and properties to the manifest as needed and as the network services evolve. The manifest may include some network data, including file size, resource allocation, path selection, etc.

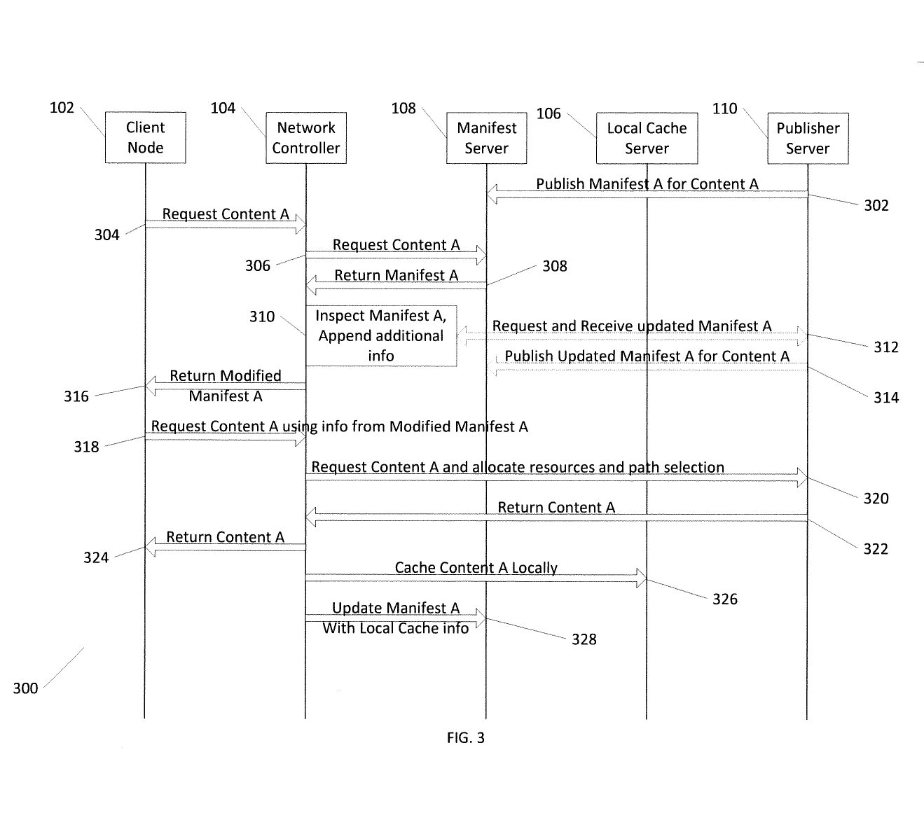

FIG. 3 shows a sequence flow 300 for requesting and processing a manifest. Sequence flow 300 begins at step 302 with the publication of a Manifest A by publisher server 110 to manifest server 108. Manifest A is associated with a content object, Content A, created by publisher server 110. Manifest server 108 maintains Manifest A for use in network architecture 100. Client node 102 sends a request for Content A to network controller 104 at step 304. Alternatively, client node 102 may specifically send a request for Manifest A to network controller 104. Network controller 104 forwards the request to manifest server 108 at step 306. At step 308, manifest server 108 returns Manifest A to network controller 104.

At step 310, network controller 104 inspects Manifest A and, if permitted in one embodiment, modifies Manifest A by adding an appendix with any other network information pertinent to Manifest A and Content A. In another embodiment, network controller 104 may request modification in step 312 of Manifest A with publisher server 110 and receive an updated Manifest A. Publisher server 110 also notifies manifest server 108 of the updated Manifest A at step 314. Upon modification of Manifest A, network controller 104 sends the modified Manifest A to client node 102 in step 316.

From the information in modified Manifest A, client node 102 sends a message at step 318 to specifically requesting Content A. Network controller 104 determines resource allocation and path selection for routing of Content A and sends out a message at step 320 to retrieve Content A. If Content A is cached within network architecture 100, the cached copy of Content A is retrieved. If not cached, the message at step 320 is processed by publisher server 110 for retrieval of Content A.

Content A is returned at step 322, either from publisher server 110 or a cache within network architecture 100. Network controller 104 provides Content A to client node 102 at step 324. Network controller 104 also determines whether Content A is to be stored in Local Cache server 106. If so, network controller 104 sends a copy of Content A to Local Cache server 106 at step 326 for subsequent direct retrieval upon receiving another request for Content A. If Manifest A was modified by an appendix thereto, network controller 104 sends a Manifest A update message at step 328 to manifest server 108 so that manifest server 108 updates its information concerning Manifest A.

For use of the manifest by the network controller 104, there are several options depending on what is allowed to be included in the manifest and how the network controller can modify the manifest. The manifest resolution preferably occurs on a dedicated port, for example TCP port 53. As a result, the network controller 104 monitors such a specific port to filter out manifest traffic. Note that this is a significant difference with HTTP requests, where all the traffic is on the same port and therefore identifying content requests require parsing the content object. If the network controller 104 is allowed to modify the manifest and has copies of the content object cached, the network controller 104 may insert the information regarding local copies of the content object into the manifest, provide preference coefficients so that the client node 102 prefers the local copy versus other network cached copies, and include network labels to facilitate routing and prepare path establishment to the content object. If a request from a client node 102 is received, network controller 104 may appropriately route the request using content-based optimization. The network label may be an IP address for the content object that is specific to a path. To reach the cache via a certain path, one can associate an IP address while the same cache reached by a different path would be associated a different IP address. The label could also be a combination of IP address and MPLS label, or just a different protocol altogether that would present a specific label at the network layer for routing in the specified manner. By load balancing the different paths according to the label, the network controller 104 can achieve significant performance gain and reduced response time.

When receiving Manifest A, the network controller 104 may rank the list of locations for Content A or add some preference for specific locations. In addition, network controller 104 may pre-fetch Content A if not already cached upon receiving Manifest A and add the location of the pre-fetched copy of Content A when modifying Manifest A. Network controller 104 may also advertise services when modifying Manifest A to enhance data delivery.

One approach to modifying the manifest may include one or more network appendices or fields separated from the publisher's manifest that can be modified by intermediary network controllers. The appendices may be added and signed by an intermediary network controller and therefore not included in the manifest part that is signed by the publisher. One technique is a recursive definition of the manifest. The publisher's manifest is encapsulated into another network manifest that is signed by the last authority that modifies the publisher's manifest. Each layer of the network manifest includes the publisher's manifest signed by the content provider and adds some extra information in an appendix signed by the particular network controller.

Another approach is that the network controller wishing to modify the manifest makes a modification request with the publisher. For instance, a network controller wishing to cache the content object would insert its cache location in the location field of the manifest. Such a modification would require the publisher to generate and publish a new manifest with this cache location. Though this inserts a delay and requires a protocol between the network controller 104 and publisher server 110 to add the proposed information into the manifest, it also ensures that copies of the content object are authorized. The publisher server 110 may only let certain (trusted) entities cache the content.

Another alternative is a manifest of manifests. An intermediary network controller may create a network manifest to a certain name that holds other manifests created by other entities. This is similar to the encapsulation approach above but allows several manifests to be included into a new manifest instead of a string of one manifest in a manifest in a manifest, etc.

If the network cannot modify the manifest, the client node 102 may include a new step before requesting the content object. Namely, as the network controller 104 and the client node 102 acquire the manifest, the client node 102 may notify the network before a transaction begins. For a Software-Defined Networking (SDN) configuration using the OpenFlow communication interface, this is done implicitly by sending the first packet of the session and having a switch notice it is a new flow. The packet is then forwarded to a network controller for selection of the path/resource to allocate. Here, the client node 102 may explicitly notify the network controller 104 directly to request the set-up of the path prior to sending any other communication based upon the information in the manifest. A separate client node to network controller protocol may be utilized to accomplish such a task. Currently, the client nodes in a SDN network are not necessarily aware of the network controller's location. However, the network can be configured to forward packets to the network controller 104 for new sessions and the manifest request sent by the client node 102 is considered as the first packets of a new session. As a result, the first packet of the request for the manifest made by the client node becomes an explicit control packet and the network controller 104 need not try to infer how to handle the stream from the client node 102 as in the OpenFlow protocol.

The query protocol for a manifest may be similar to a Domain Name System (DNS) question using existing DNS question syntax (modified to accommodate file names instead of domain names). DNS is a protocol within the set of standards for how computers exchange data on the Internet and on many private networks, known as the TCP/IP protocol suite. One of its basic functions is to turn a user-friendly domain name like “howstuffworks.com” into an Internet Protocol (IP) address like 70.42.251.42 that computers use to identify each other on the network. Computers and other network devices on the Internet use an IP address to route a request to the site the device is trying to reach. Thanks to DNS, a user does not have to keep an address book of IP addresses. Instead, connection is performed through a DNS server, which manages a massive database that maps domain names to IP addresses. Whether you're accessing a Web site or sending an e-mail, a computer uses a DNS server to perform a look up on the domain name being accessed. The proper term for this process is DNS name resolution as the DNS server resolves the domain name to the IP address. For example, when entering “http://www.howstuffworks.com” in a browser, part of the network connection includes resolving the domain name “howstuffworks.com” into an IP address 70.42.251.42 corresponding to HowStuffWorks' Web servers. A DNS lookup may be bypassed by entering 70.42.251.42 directly in the browser. However, a user is probably more likely to remember “howstuffworks.com” than the numbered IP address. In addition, a Web site's IP address can change over time and some sites associate multiple IP addresses with a single domain name. Typically, when connecting to a home network, Internet service provider (ISP) network, or Wi-Fi network, the modem or router that assigns a computer's network address also sends some important network configuration information to the computer or mobile device. That configuration includes one or more DNS servers that the device should use when translating DNS names to IP address.

The response to a DNS request is an answer resource record identifying the IP address. According to an embodiment, the resource record becomes a manifest file/object with a variable length. Though a new protocol could be designed to specifically query a manifest instead of a resource record, since the manifest includes location of the content object, it is preferable to leverage the existing DNS protocol and extend DNS rather than create a new protocol to perform a similar function. As a result, the DNS protocol may be used to obtain a description of a content object instead of retrieving a location. The round trip time in obtaining a manifest is the same as the round trip time in obtaining an IP address in a DNS query

There are several significant differences between the DNS protocol and the presently disclosed protocol. First, the response to a query is now a manifest file, rather than an IP address. This manifest file may be relatively large. DNS uses UDP on port 53, but TCP is used if the response is larger than some threshold and some DNS resolvers use TCP for all queries. For purposes of the present disclosure, manifest server 108 preferably uses TCP for all queries. Second, a DNS request is sent first to a local DNS server and, if the DNS server does not have the requested resource record, the request will be propagated to other DNS servers, typically in a hierarchical manner for final resolution. The response is then propagated back to the original DNS server associated with the request. If all requests are sent by the original manifest server, then the network controller 104 can learn from the manifest what files will cross the network. However, this does not include the actual location of the requester of the content. The requester of the content may have configured DNS statically and could be in a different domain. Therefore, a manifest response to a query may indicate what traffic will flow in the network but may not indicate where the traffic will flow and if it will actually even flow through this specific network. DNS would provide a hint, which could be confirmed later during the data exchange. However, a new protocol could include the location of the content requester into the manifest request. The query syntax would therefore include, instead of a 16 bit transaction ID as in current DNS, a 32 bit IP address for the requester. This would come at the cost of less privacy for the end user of client node 102, as each request would be associated with its requester at the manifest server level.

Since manifest requests are issued for all files, the number of manifest exchanges increases dramatically. Under DNS, a request for many YouTube videos would resolve www.youtube.com only once. The subsequent requests would know the IP address of the YouTube server. The manifest information however of a second video would not be included in the manifest of the first one, except maybe for the location of the server which could be identical (or not, if the files are cached on different servers). A request per file may be used to notify the network controller of the file transfer. Possible solutions to the increase in the number of requests include aggressive caching of the manifests into local manifest servers. Alternatively, a compression of a manifest may be performed, for instance by compressing common information with respect to a previous manifest from a similar file (as in for two YouTube videos).

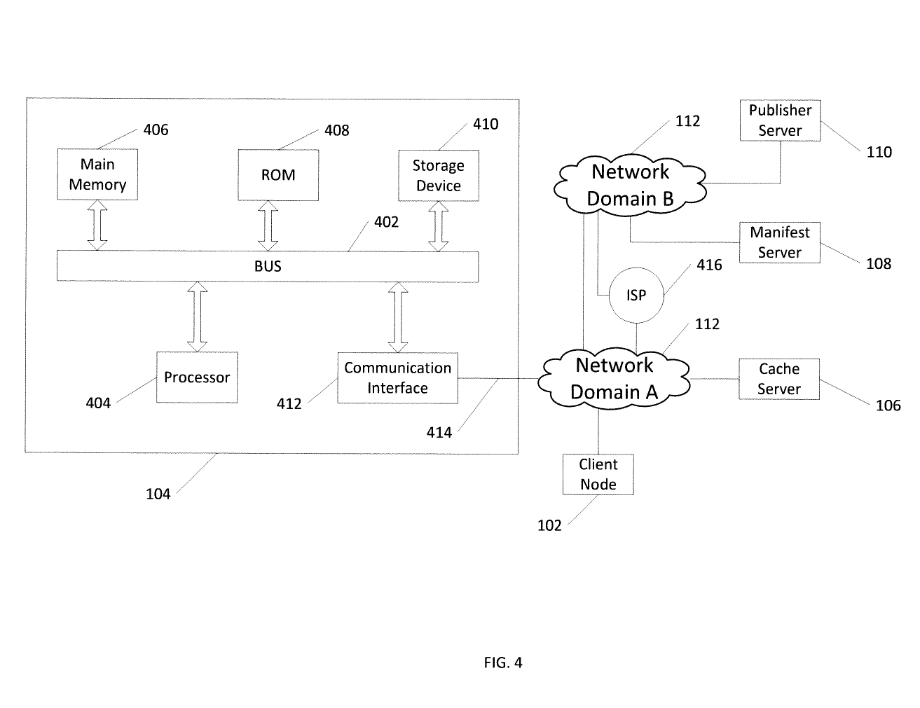

FIG. 4 is a block diagram that illustrates an example structure of network controller 104 upon which an embodiment of the invention may be implemented. Network controller 104 includes a bus 402, or other communication mechanism for communicating information, and a processor 404 coupled with bus 402 for processing information. Network controller 104 also includes a main memory 406, such as a random access memory (“RAM”) or other dynamic storage device, coupled to bus 402 for storing information and instructions to be executed by processor 404. Main memory 406 also may be used for storing temporary variables or other intermediate information during execution of instructions to be executed by processor 404. Network controller 104 may further include a read only memory (“ROM”) 408 or other static storage device coupled to bus 402 for storing static information and instructions for processor 404. A storage device 410, such as a magnetic disk or optical disk, may also be provided and coupled to bus 402 for storing information and instructions.

In some embodiments, network controller 104 can be used for the routing and processing of manifests. According to one embodiment, manifest processing is provided by network controller 104 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

Network controller 104 also includes a communication interface 412 coupled to bus 402. Communication interface 412 provides a two-way data communication coupling to a network link 414 that is connected to a local network, such as network domain A 112. For example, communication interface 412 may be an integrated services digital network (“ISDN”) card or a modem to provide a data communication connection to a corresponding type of telephone line. As another example, communication interface 412 may be a local area network (“LAN”) card to provide a data communication connection to a compatible LAN. Wireless links may also be implemented. In any such implementation, communication interface 412 sends and receives electrical, electromagnetic, or optical signals that carry digital data streams representing various types of information.

Network link 414 typically provides data communication through one or more networks to other data devices. For example, network link 414 may provide a connection through network domain A 112 to client node 102 or to data equipment operated by an Internet Service Provider (“ISP”) 416. ISP 426 in turn provides data communication services through network domain B 112, which may be the world wide packet data communication network now commonly referred to as the Internet. Network domain A and network domain B 112 may both use electrical, electromagnetic, or optical signals that carry digital data streams. The signals through the various networks and the signals on network link 414 and through communication interface 412, which carry the digital data to and from network controller 104, are exemplary forms of carrier waves transporting the information.

Network controller 104 can send messages and receive data, including program code, through the network(s), network link 414, and communication interface 412. Publisher server 110 or manifest server 108 might transmit a requested code for an application program through network domain B 112, network domain A 112, and communication interface 412. In accordance with the invention, one such downloaded application provides for manifest processing as described herein. The received code may be executed by processor 404 as it is received, and/or stored in storage device 410, or other non-volatile storage for later execution. Other entities of network architecture 100 may have the same or similar structure as network controller 104.

In summary, the present disclosure provides a new explicit network abstraction to signal properties of all content ahead of time before content is requested and forwarded. A manifest is created for all content objects in a network to provide more information about the data to network entities and the client node. A 50% gain in resource utilization may be achieved by having perfect knowledge of content object size in advance. A network controller makes caching information/resource allocation/store-and-forward decisions based on data analysis of the information in a manifest. A manifest may indicate different locations for a content object and the network controller can calculate a “best” location for the content and modify the manifest accordingly.

In some embodiments, some or all of the functions or processes of the one or more of the devices are implemented or supported by a computer program that is formed from computer readable program code and that is embodied in a computer readable medium. The phrase “code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, changes, substitutions, alterations, and permutations of these embodiments and methods will be apparent to and readily discernable by those skilled in the art without departing from the scope of this disclosure as defined by the following claims. Accordingly, the above description of example embodiments does not define or constrain this disclosure and the present invention should not be construed as being limited by such example embodiments but rather construed according to the following claims.

What is claimed is:

1. A method for retrieving a content manifest in a network, comprising:
requesting a manifest from a manifest server in response to a query from a client node, the manifest being an extensible description of content to be requested;
receiving the manifest from the manifest server;
modifying the manifest to include a location for the content; and
providing the modified manifest to the client node.

2. The method of claim 1, wherein modifying the manifest includes adding an appendix to the manifest, the appendix including changes and additions to the manifest.

3. The method of claim 1, wherein modifying the manifest includes:
requesting an updated manifest from a publisher server that created the manifest; and
receiving the updated manifest from the publisher server.

4. The method of claim 1, further comprising:
receiving a request for the content associated with the modified manifest from the client node;
allocating resources and path selection for retrieval of the content;
retrieving the content; and
providing the content to the client node.

5. The method of claim 4, further comprising:
determining whether the content is to be cached locally; and
caching the content locally in response to the determination.

6. The method of claim 5, further comprising:
updating the manifest with local caching information; and
providing the updated manifest to the manifest server.

7. The method of claim 1, further comprising:
pre-fetching the content upon receiving the manifest; and
including a location of the pre-fetched content in the modified manifest.

8. A non-transitory computer readable medium including code for retrieving a content manifest in a network, the code upon execution operable to:
request a manifest from a manifest server in response to a query from a client node, the manifest being an extensible description of content to be requested;
receive the manifest from the manifest server;
modify the manifest to include a location for the content; and
provide the modified manifest to the client node.

9. The computer readable medium of claim 8, wherein the code for modifying the manifest includes code operable to add an appendix to the manifest, the appendix including changes and additions to the manifest.

10. The computer readable medium of claim 8, wherein the code for modifying the manifest includes code operable to:
request an updated manifest from a publisher server that created the manifest; and
receive the updated manifest from the publisher server.

11. The computer readable medium of claim 8, wherein the code is further operable to:
receive a request for the content associated with the modified manifest from the client node;
allocate resources and path selection for retrieval of the content;
retrieve the content; and
provide the content to the client node.

12. The computer readable medium of claim 11, wherein the code is further operable to:
determine whether the content is to be cached locally; and
cache the content locally in response to the determination.

13. The computer readable medium of claim 12, wherein the code is further operable to:
update the manifest with local caching information; and
provide the updated manifest to the manifest server.

14. The computer readable medium of claim 8, wherein the code is further operable to:
pre-fetch the content upon receiving the manifest; and
include a location of the pre-fetched content in the modified manifest.

15. A system for retrieving a content manifest in a network, comprising:
a client node operable to send a query for a manifest, the manifest being an extensible description of content to be requested;
a manifest server operable to maintain manifests; and
a network controller operable to request the manifest from the manifest server, modify the manifest to include a location for the content, and forward the modified manifest to the client node.

16. The system of claim 15, wherein modifying the manifest includes adding an appendix to the manifest, the appendix including changes and additions to the manifest.

17. The system of claim 15, further comprising:
a publisher server operable to create the content and the manifest;
wherein the network controller is operable to request an updated manifest from the publisher server and receive the updated manifest from the publisher server.

18. The system of claim 15, wherein the network controller is operable to receive a request for the content associated with the modified manifest from the client node, allocate resources and path selection for retrieval of the content, retrieve the content, and provide the content to the client node.

19. The system of claim 18, wherein the network controller is operable to cache the content locally, update the manifest with local caching information, and provide the updated manifest to the manifest server.

20. The system of claim 15, wherein the network controller is operable to pre-fetch the content upon receiving the manifest and include a location of the pre-fetched content in the modified manifest.
